(19) United States
(12) Patent Application Publication
(10) Pub. No.: US 2024/0261745 A1
(43) Pub. Date: Aug. 8, 2024

(54) ROTATION INFLUENCING MIXING CONTAINER SYSTEM AND METHOD

(71) Applicant: Big Mountain Innovations, LLC, Whitefish, MT (US)

(72) Inventor: Josep Feliu, Whitefish, MT (US)

(73) Assignee: Big Mountain Innovations, LLC, Whitefish, MT (US)

(21) Appl. No.: 18/104,864

(22) Filed: Feb. 2, 2023

(51) Int. Cl. B01F 33/501; A47J 47/02; B65D 43/02

(52) U.S. Cl. CPC B01F 33/5011; A47J 47/02; B65D 43/0212; B65D 2543/00092; B65D 2543/00351; B65D 2543/00527; B65D 2543/00537; B65D 2543/00648; B65D 2543/00685; B65D 2543/0074; B65D 2543/00805

(57) ABSTRACT

The invention disclosed herein provides a system and method of configuration of a rotation influencing culinary mixing container. The system provides even the most novice users a system of providing even coating of spices, seasoning, and other dry or wet ingredients to food items. The uniquely configured curved base and domed lid of the system work to achieve the uniform coating. The rotation influencing culinary mixing container system includes a hollow cavity-defining main body constructed of two hemispheres. The two hemispheres include a base bowl lower hemisphere and a domed lid upper hemisphere. The base bowl lower hemisphere is defined by a linear upper surface with a substantially circular opening in the upper surface and a semi-spherical cavity. The domed lid upper hemisphere is defined by a linear lower surface with a substantially circular opening in the lower surface and a semi-spherical cavity.

### FIELD OF THE INVENTION

The present invention relates mixing bowls and seasoning devices for both dry and wet contents.

### BACKGROUND

Seasoning is one of the most important steps in culinary practice. While the method of preparation plays a large role, complex flavors that set dishes apart from one another can thank the use of unique combinations of different spices. In some methods of preparation, recipes call for adding spices directly to the food at different stages. However, when preparing meats and fish, seasoning is most popularly added before to allow the flavors to cook with the meat or fish. While some preparations include wet marinades, dry rubs are also popular, but even coating can be tricky.

Mixing, tossing, marinating, seasoning and coating are all a process that consists of combining ingredients, such as a salad, and/or applying a liquid or a powder onto the surface of an edible product to convey new properties. Mixing involves the combining of ingredients in such a manner that all are distributed evenly amongst each other. Mixing ingredients of a food dish, such as salads and pasta, uses a light lift and drop method. Tossing involves lightly combining ingredients usually using your hands, tongs, or other common kitchen utensils. Tossing allows air into your food items and incorporates the ingredients in a more evenly distributed manner. Marinating involves soaking food in a flavorful liquid, allowing a sauce or flavoring mixture to absorb into something. Seasoning involves ensuring an ingredient such as an herb or a spice, evenly adheres to food items. Even seasoning of ingredients is most desirable as seasoning is typically added to food primarily for the savor that it imparts. Coating involves the application of a layer of seasoning, liquids, or solids onto a food product.

A problem arises when attempting any of the above mentioned methods, because it is difficult to quickly, efficiently, and effectively produce uniform results, which decreases the overall flavor, texture, and enjoyment of the food itself. Further, when not uniformly coated there is a large amount of wasted seasoning and spice mixtures.

Current application of dry seasoning include seasoning the meat and flipping it to season the other side, but this can mess with the coating on the surface facing down. Others place the meat in a bag with seasonings and shake, but this can require excessive amounts of seasoning to get equal dispersion across the meat. Others with advanced culinary skills use mixing bowls, but even coatings are only a characteristic of those meals prepared by individuals with exceptional culinary skills and experience. Lastly, individuals may try to bridge this gap using reusable food containers, such as a lidded Tupperware®.

While in a different area of use, patents disclosing raised lids in the industry of foods grade storage products are available. Some of these disclosures include U.S. Pat. No.: 3,912,118 to Bird, entitled “Container Lid”, U.S. Pat. No.: 3,955,710 to Commisso, entitled “Covered Container for Serving Food with Combination Ventilation and Finger Holes”, U.S. Pat. No.: 5,894,953 to Ramirez, entitled “Vented Bowl and Cover Assembly”, U.S. Pat. No.: 3,794,090 to Commisso, entitled “Covered Container for Serving Food”, U.S. Pat. No.: 4,341,324 to Ramirez, entitled “Bowl and Cover Assembly”, U.S. Pat. No.: 10,486,856 to Mundy et al., entitled “Plate Attachment Assembly, U.S. Pat. App.: 2003/0155353 to Tucker, entitled “Plate Container with Detachable Cover”, and U.S. Pat. App.: 2005/0161455 to Studee, entitled “Tamper Resistant Container”.

Typically, the above discussed solutions result in clumping of seasoning and other areas that are untouched. However, as will be discussed below, there are no products on the market today that provide a domed lid system with living hinge locks to allow food to completely circulate and coat food products evenly. The referenced patents disclose inventions that aren't equipped to solve this problem because, inter alia, they lack the substantially spherical angulation necessary for the enhanced mixing as disclosed in the invention, herein.

Thus, a need exists in the market for a solution that provides even the most novice users a system of providing even coating of spices, seasoning, and other dry or wet ingredients to food items. The uniquely configured curved base and domed lid of the system disclosed herein meets this need. Further, an interchangeable flat lid allows for temporary food storage. With storage space at a premium in many kitchens, the domed lid fits inside the base so it can be easily stacked in traditional-sized cabinets. The product allows younger children to help in the kitchen while also allowing older adults to toss food more easily due to its more secure closure design system.

### SUMMARY OF THE INVENTION

The invention disclosed herein provides a rotation influencing culinary mixing container system. The rotation influencing culinary mixing container system includes a hollow cavity-defining main body constructed of two hemispheres. The two hemispheres include a base bowl lower hemisphere and a domed lid upper hemisphere. The base bowl lower hemisphere is defined by a linear upper surface with a substantially circular opening in the upper surface and a semi-spherical cavity recessing down into the base bowl hemisphere with a diameter of the semi-spherical cavity decreasing in size as the spherical cavity reaches a lower center point. The domed lid upper hemisphere is defined by a linear lower surface with a substantially circular opening in the lower surface and a semi-spherical cavity recessing up into the domed lid hemisphere with a diameter of the semi-spherical cavity decreasing in size as the spherical cavity reaches an upper center point.

Also provided in the rotation influencing culinary mixing container system is a compression rim integrally formed onto each respective hemisphere extending laterally outward from the each respective substantially circular opening, thereby providing an upper surface and lower surface for user engagement and forming a pair of opposing compression rims.

A substantially spherical interior surface bordering the hollow cavity is also provided. The substantially spherical interior surface is formed from an alignment of the semi-spherical cavity of the base bowl lower hemisphere with the semi-spherical cavity of the domed lid upper hemisphere and the base bowl lower hemisphere and the domed lid upper hemisphere are pressed together, wherein the substantially spherical interior surface guides momentum generated from tossing and shaking contents within the substantially spherical interior in a circular directional motion and influencing a rotation of the contents to allow dry and wet particulates to coat interior contents evenly.

The invention disclosed herein also provides a method of configuring a culinary mixing container for enhanced rotational influence. The method comprises providing a two-part culinary mixing container having a domed lid upper hemisphere and a base bowl lower hemisphere, implementing a spherical hollow cavity within the two-part culinary mixing container by configuring a semi-spherical internal surface in the domed lid upper hemisphere with an opening at a lower linear surface, and configuring a semi-spherical internal surface in the base bowl lower hemisphere with an opening at an upper linear surface, whereby a circumference of the opening at the lower linear surface is identical to a circumference of the opening at the upper linear surface. The method also includes configuring an circumferential arch integration point comprising an upper circumferential integration point along a periphery of the opening at the upper linear surface of the domed lid upper hemisphere and a lower circumferential integration point along a periphery of the opening at the lower linear surface of the base bowl lower hemisphere, whereby once pressed together, the opening at the lower linear surface and the opening at the upper linear surface align forming a continuous arched surface to thereby guide momentum generated from tossing and shaking contents within the substantially spherical interior in a circular directional motion and influencing a rotation of the contents to allow dry and wet particulates to coat interior contents evenly.

It is an object of the present invention to provide a system that evenly coats food items such as meats, fishes, and vegetables evenly in seasoning.

It is yet another object of the present invention is to provide a system capable of influencing rotation of the internal contents of the system in a continuously circulation movement.

It is a further object to provide a reusable and easy to store system that can be integrated and stored with a user's other mixing bowls.

The drawings and specific descriptions of the drawings, as well as any specific or alternative embodiments discussed, are intended to be read in conjunction with the entirety of this disclosure. The invention may be embodied in many different forms and should not be construed as being limited to the embodiments set forth herein; rather, these embodiments are provided by way of illustration only and so that this disclosure will be thorough, complete and fully convey understanding to those skilled in the art. The above and yet other objects and advantages of the present invention will become apparent from the hereinafter set forth Brief Description of the Drawings, Detailed Description of the Invention, and Claims appended herewith.

### BRIEF DESCRIPTION OF THE DRAWINGS

FIG. 1 illustrates a side elevational view of the mixing container system.

FIG. 2 illustrates is a side cross sectional view of the mixing container system showing the influence of contents therein.

FIG. 3 illustrates a side cross sectional view of the mixing container system.

FIG. 4 illustrates an enlarged view of the press closable rims of the top and bottom of the mixing container system with gasket therebetween.

FIG. 5 illustrates a top view of the press sealing gasket.

FIG. 6 illustrates a side elevational view of an embodiment of the mixing container system with a plurality of locking latches.

FIG. 7 illustrates as side elevational view of the base portion of the embodiment of the mixing container system of FIG. 6.

FIG. 8 illustrates an isometric view of the base portion of the embodiment of the mixing container system of FIG. 7.

FIG. 9 illustrates as side elevational view of the top portion of the embodiment of the mixing container system of FIG. 6.

FIG. 10 illustrates a top view of the top portion of the embodiment of the mixing container system of FIG. 9.

### DETAILED DESCRIPTION OF THE INVENTION

The invention herein provides a solution for uneven application of spices, marinades, and rubs on to foods such as meat, fish, and vegetables. The invention includes a uniquely configured two-part circular bowl system capable of solving the above issues by implementing a rotation-inducing geometry, which provides an even coating to such food items.

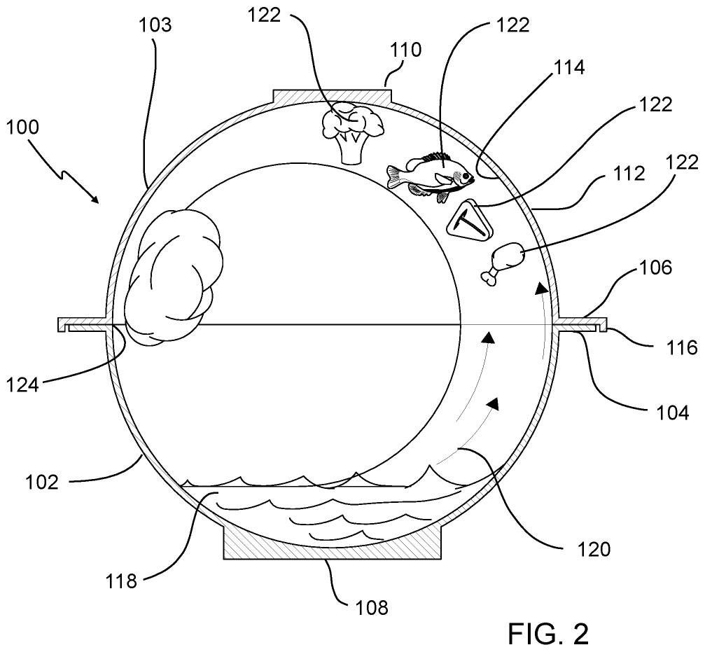

Currently, mixing, tossing, marinating, seasoning, and coating food items is typically completed by using mixing bowls with no lid, using a flat storage lid, or the aforementioned activities are completed manually in plastic bags, commonly referred to as Ziploc® baggies. These containers are meant primarily for storage. Using this storage system, typically a combination of a container and a flat lid system, to mix, marinate or coat food interrupts the full range of rotation motions needed for through tossing and coating of food items, resulting in poor or limited coverage of ingredients. The plastic baggie method often leads to attempting to massage the ingredients into the food items, with similarly poor results. The domed lid mixing system 100 proposed herein allows all ingredients 118/122 to complete a full rotation, as illustrated in FIG. 2, providing even coverage of all ingredients 118/122.

The current invention solves these problems by Implementing a multi-use bowl system 100 including, in an exemplary embodiment, a unitary open-topped container 102, an air-tight dome shaped lid 103 (comprising the domed lid with an optional opening at the top center with an airtight cap system) and an optional flat lid suitable for storage of food items 122. Both the domed mixing lid 103 and the flat storage lid systems may be a plastic lid. The lid may including the cover portion and a plurality of lid latches 136 connected to the lid cover portion by living hinges 144, and a seal gasket 126 fitted into an inner seal channel 128 formed in a lid peripheral rim 104. The latches 126 are configured for movement between extended positions in which the lid 103 is removable from the container 102, and a latching position in which latch 136 features engage a peripheral edge of the container to secure the lid 103 and gasket 126 in a sealed position on the container 102. The purpose of the domed lid 103 is to enhance and improve the tossing, mixing, and coating of any used ingredients. Though the optional opening at the top center of the lid 103 and the optional flat lid for storage may not be explicitly shown in the figures, the integration of these features should be readily apparent to a person of skill in the art.

The bowl 102 and domed lid 103 system 100 allows all the ingredients 118/122 used to be quickly and evenly coated, resulting in uniform taste and texture. The key to the efficiency of the bowl 102 and domed lid 103 is the rolling motion created by the rounded lid 103. This allows the food items the room needed to fully circulate or rotate within the bowl 102/103 because it does not stop or interfere in the natural motion of a tossing action.

From reading this disclosure, and the teachings imparted within, it may prompt a user to place mixing contents in a food grade container, such as those disclosed in prior inventions, such as those recited in the background: U.S. Pat. No.: 3,912,118 to Bird, entitled “Container Lid”, U.S. Pat. No.: 3,955,710 to Commisso, entitled “Covered Container for Serving Food with Combination Ventilation and Finger Holes”, U.S. Pat. No.: 5,894,953 to Ramirez, entitled “Vented Bowl and Cover Assembly”, U.S. Pat. No.: 3,794,090 to Commisso, entitled “Covered Container for Serving Food”, U.S. Pat. No.: 4,341,324 to Ramirez, entitled “Bowl and Cover Assembly”, U.S. Pat. No.: 10,486,856 to Mundy et al., entitled “Plate Attachment Assembly, U.S. Pat. App.: 2003/0155353 to Tucker, entitled “Plate Container with Detachable Cover”, and U.S. Pat. App.: 2005/0161455 to Studee, entitled “Tamper Resistant Container”.

However, it will become readily apparent that these solutions are inferior to the product herein because the rotation arc will be different and the curvature needed to influence the contents, including food items and seasonings, will not spin as needed for an even coating. While a combination of the above referenced disclosures will inevitably provide coating to some extent, it is not the even coating that results from the application of the invention in the disclosure herein. That is, while surfaces will be coated, there will be pockets of uncoated surfaces and clumping in others, not to mention the excessive sticking on sidewalls of the containers due to lack of rotational momentum.

From a materials standpoint, the mixing system 100 can be primarily constructed of plastic in some embodiments, and stainless-steel other embodiments, though it should be appreciated that the principles of the invention do not cease to function regardless of the material, and in that respect, materials including even glass may be used so long as they are stable under such compression and pressure of operation. Gaskets may be constructed of compressible materials such as rubbers and plastics, but will mostly be constructed of food grade silicone. Further, a combination of materials may be integrated, for example, a stainless-steel base 102 and a plastic lid 103 with integrated living hinges 144 and latches 136. In addition, a non-slip silicone base may also be added for storage and placement while the system is being filled with contents 118/122. The non-slip silicone base may be glued or bonded to the system container body 100 material. Though these features may not be explicitly shown in the figures, the integration of these features should be readily apparent to a person of skill in the art.

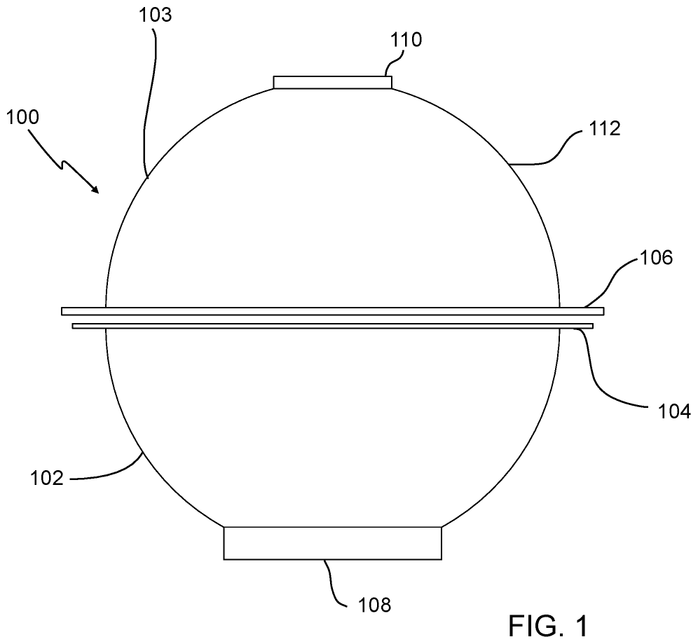

The rotation influencing culinary mixing container system of the present invention may be used to provide a system that evenly coats food items such as meats, fishes, and vegetables evenly in seasoning, to provide a system capable of influencing rotation of the internal contents of the system in a continuously circulation movement, and to provide a reusable and easy to store system that can be integrated and stored with a user's other mixing bowls. This apparatus and system are particularly shown in FIGS. 1-10.

FIG. 1 illustrates a side elevational view of the mixing container system 100. As may be seen, the mixing container system is separated in to two hemispheres, the bottom bowl 102, and the domed lid 103. Each hemisphere is semicircular, having an opening at a widest portion, and a rim 104/106 surrounding this opening. The outer curvature 112 may be noticed from the figure, however, the outer surface may vary geometrically as long as it does not affect the internal curvature 114 (Shown in FIG. 2). As noticed, the lid 103 and bowl 102 may also contain a flat portion or base 108/110, which may be used to secure the spherical system 100. In addition, flat portion 110 may also include or be configured as a removable cap, thereby allowing an opening for contents to be added. It should also be appreciated that the rim 106 of the lid 103 is shown to be slightly larger than the rim 104 of the base bowl 102, because, as shown in other Figures, the upper rim 106 fits over the lower rim 104 in some embodiments, helping temporarily seal the inside cavity.

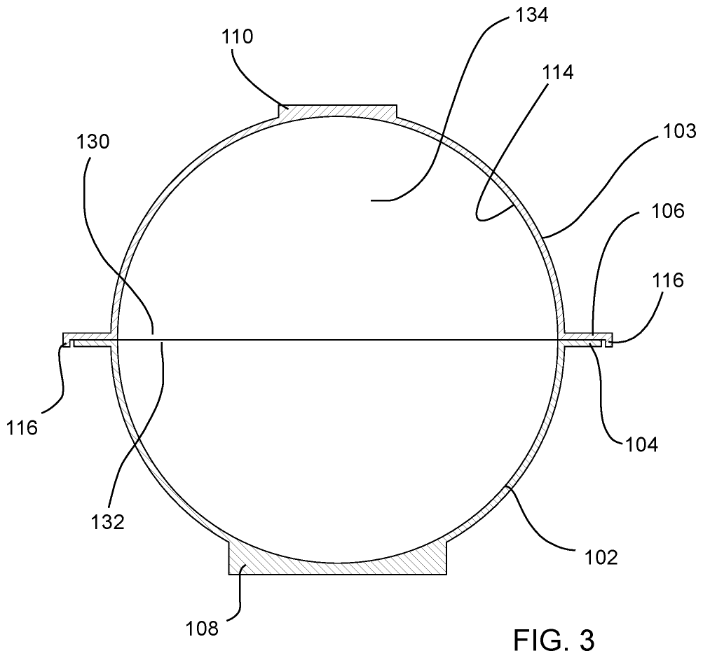

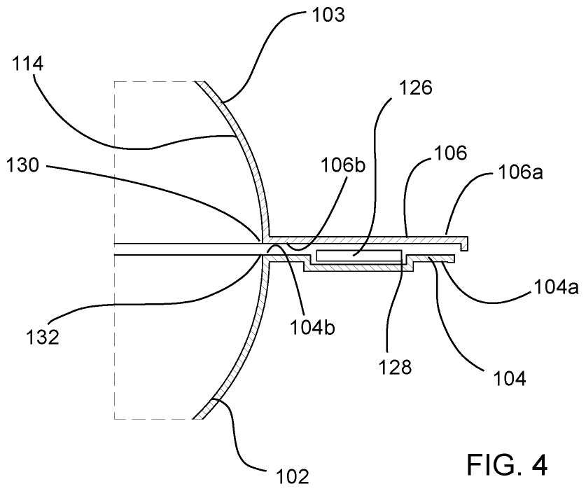

FIG. 2 illustrates is a side cross sectional view of the mixing container system 100 showing the influence of contents 118/122 therein. FIG. 2 also illustrates the most important aspects of the invention including the internal substantially spherical surface 114, which is configured to influence a rotation 120 of the contents 118/122 when used by an individual. The upper rim 106 is pressed by a user on its upper surface 106a (emphasis shown in FIG. 4) and the lower rim 104 is pressed by a user on its lower surface 104a (emphasis shown in FIG. 4), thereby compressing any space between the lower surface 106b of the upper rim 106 and the upper surface 104b of the lower rim 104. This creates the arc integration point 124, which is geometrically defined as a substantially continuous radial surface that is capable of continuous rotation and facilitation of the radial momentum and guidance of the contents 118/122 inside the substantially spherical cavity 134 (emphasized in FIG. 3). A lip 116 may also be added to the upper rim 106 so that the boundary of the lower rim 104 may be caught within, thereby containing and ensuring a proper alignment at the arc integration point 124 inside the container system 100.

FIG. 3 illustrates a side cross sectional view of the mixing container system, similar to that of FIG. 2, however, FIG. 3 directs the focal point to an empty system 100. As may be seen in FIG. 3, the combination of the open area of inside of the lid 103 and the open area of the inside of the bowl 102 creates a substantially spherical chamber 134. While it may be possible to modify the overall shape of the chamber slightly, it is to be appreciated that any drastic changes in surface orientation, such as those from the patent disclosures referenced in the background section, could materially affect the rotational capabilities of the system 100 and render the invention inefficient and unusable for the intended purpose. It is, however, to be appreciated, that small flat portions may be integrated in to the top and bottom of the internal cavity 134 (not emphasized), so long as they do not affect the rotational influencing capabilities of the walls. That is, the inner walls 114 need to continue the circular motions and influence rotation.

Also shown in FIG. 3 is the upper hemisphere of the arch integration point 130 and the lower hemisphere of the arch integration point 132.

FIG. 4 illustrates an enlarged view of the press closable rims of the top and bottom of the mixing container system with gasket therebetween. It is important to understand the mechanics of the rims 106/104 of the system 100 because they illustrate the solution to aligning the internal wall 114 to provide a substantially continuous arched geometry. While the invention may be configured differently so as to remove the rims, the requirement must still remain that the engagement means between the upper lid 103 and the lower base bowl 102 needs to provide for a substantially continuous wall 114, which facilitates the required rotation. This is evident from the specially adapted construction to ensure the upper hemisphere of the arch integration point 130 and the lower hemisphere of the arch integration point 132 align when the gap is closed. In some embodiments, the top rim 106 and bottom rim 104 simply press together. In the illustrated embodiment of FIG. 4, a gasket 126 is also included in between the upper rim 106 and lower rim 104 in a gasket channel 128, the integrated channel that allows the gasket to recess so that when it is compressed the lower surface 106b of the upper rim 106 and the upper surface 104b of the lower rim 104 may still press on one another, sealing the arch integration point 124. FIG. 4 shown the upper surface 106a and lower surface 104a that the user presses on to accomplish this.

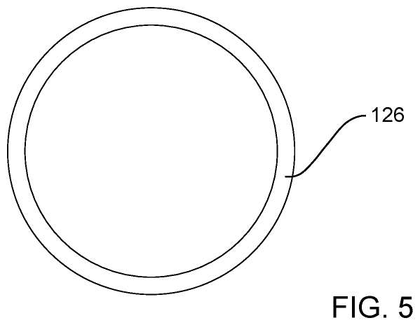

FIG. 5 illustrates a top view of the press sealing gasket 126. In some embodiments, this gasket may be made of food grade silicone. This gasket may be fixed within the channel 128 or may be removable. In some embodiments, the thickness of the gasket is approximately ½″ wide to allow a higher contact surface area and ensure no contents 118/122 escape the inner chamber 134.

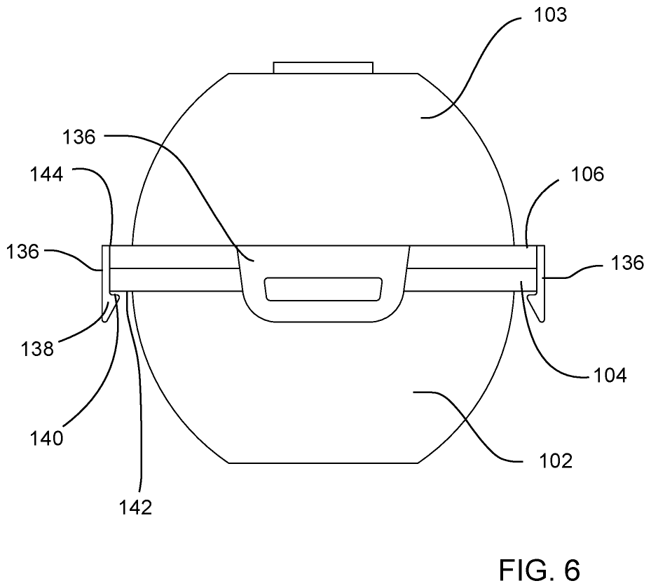

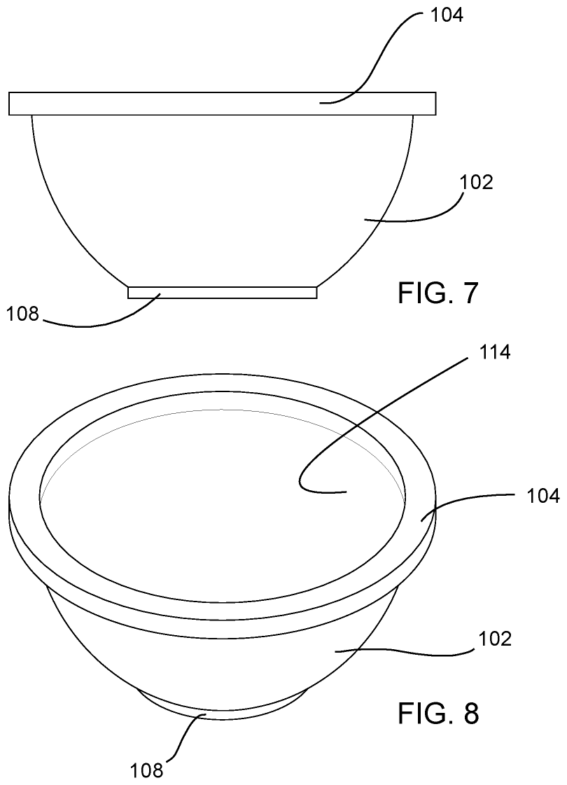

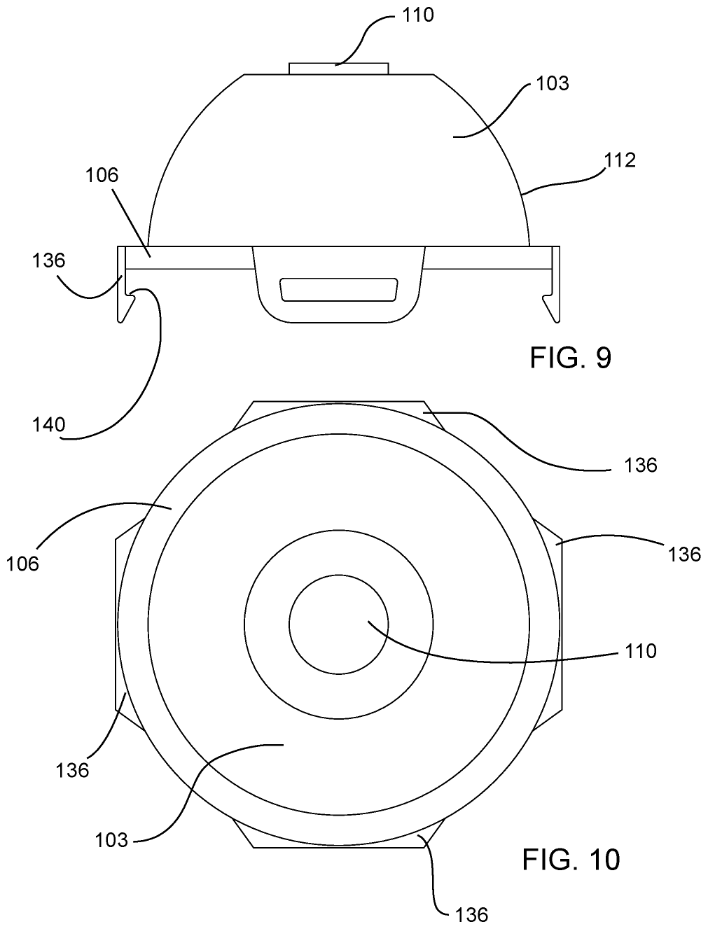

FIG. 6 illustrates a side elevational view of an embodiment of the mixing container system 100 with a plurality of locking latches 136. Like the system 100 shown in FIGS. 1-5, the system 100 shown in FIGS. 6-10 include the lid 103, the bowl base 102, upper rim 106, lower rim 104, and the same spherical internal cavity. However, rather than user-provided pressure to keep the top 103 and bottom 102 together, latches 136 provide compression pressure to lock the two halves 102/103 together. The latches 136 begin at a living hinge 144 and extend outwardly from the rim 106. The living hinge allows the triangular lock portion 138 to swing below the bottom surface 142 of the lower rim 104. The upper surface 140 of the lock portion 138 applies pressure to the bottom surface 142 of the lower rim 104, whereby the pressure keeps the lock from unlatching and keeps the two halves 102/103 of the system 100 together. FIG. 7 illustrates as side elevational view of the base portion of the embodiment of the mixing container system 100 of FIG. 6. FIG. 8 illustrates an isometric view of the base portion 102 of the embodiment of the mixing container system 100 of FIG. 7. FIG. 9 illustrates as side elevational view of the top portion 103 of the embodiment of the mixing container system 100 of FIG. 6. FIG. 10 illustrates a top view of the top portion 103 of the embodiment of the mixing container system 100 of FIG. 9.

In an exemplary embodiment, a rotation influencing culinary mixing container system 100 is provided. The system 100 includes a hollow cavity-defining main body constructed of two hemispheres 102/103, wherein the two hemispheres include a base bowl lower hemisphere 102 and a domed lid upper hemisphere 103. The base bowl lower hemisphere 102 is defined by a linear upper surface with a substantially circular opening in the upper surface and a semi-spherical cavity 134 recessing down into the base bowl hemisphere 102 with a diameter of the semi-spherical cavity decreasing in size as the spherical cavity reaches a lower center point. The domed lid upper hemisphere 103 is defined by a linear lower surface with a substantially circular opening in the lower surface and a semi-spherical cavity 134 recessing up into the domed lid hemisphere 103 with a diameter of the semi-spherical cavity decreasing in size as the spherical cavity reaches an upper center point. A compression rim 104/106 is integrally formed onto each respective hemisphere 103/102 extending laterally outward from the each respective substantially circular opening, thereby providing an upper surface 106a and lower surface 104a for user engagement and forming a pair of opposing compression rims 104/106. A substantially spherical interior surface 114 boarders the hollow cavity. The substantially spherical interior surface 114 is formed from an alignment of the semi-spherical cavity of the base bowl lower hemisphere 102 with the semi-spherical cavity of the domed lid upper hemisphere 103 and the base bowl lower hemisphere 102 and the domed lid upper hemisphere 103 are pressed together. The substantially spherical interior surface 114 guides momentum generated from tossing and shaking contents within the substantially spherical interior in a circular directional motion 120 and influencing a rotation of the contents to allow dry and wet particulates 118 to coat interior contents 122 evenly.

In some embodiments, the pair of opposing compression rims 104/106 formed into each respective hemisphere 103/102 includes an upper compression rim 106 integrated to the domed lid upper hemisphere 103 at the substantially circular opening in the lower surface of the domed lid upper hemisphere 103, and a lower compression rim 104 integrated to the base bowl lower hemisphere 102 at the substantially circular opening in the upper surface of the base bowl lower hemisphere 102. A circumferential channel 128 may be recessed within the lower compression rim 104 integrated to the base bowl lower hemisphere 102, wherein the circumferential channel 128 is configured to receive a compressible gasket 126 to seal a space between a lower surface 106b of the upper compression rim 106 and an upper surface 104b of the lower compression rim 104.

In some embodiments, the upper compression rim 106 in the pair of opposing compression rims 104/106 includes a vertical securement lip 116 extending downwardly from an outer edge of the upper compression rim 106. The securement lip 116 contains the lateral movement of the lower compression rim 104, thereby securing the alignment of the semi-spherical cavity 134 of the base bowl lower hemisphere 102 with the semi-spherical cavity 134 of the domed lid upper hemisphere 103. A circumferential channel 128 may be recessed within the lower compression rim 104 integrated to the base bowl lower hemisphere 102. The circumferential channel 128 is configured to receive a compressible gasket 126 to seal a space between a lower surface 106b of the upper compression rim 106 and the upper surface 104b of the lower compression rim 104.

In some embodiments, the rotation influencing culinary mixing container system 100 also contains a circumferential arch integration point 124 formed from a domed lid upper hemisphere 103 arch integration point 130 and lower base bowl hemisphere 102 arch integration point 132. The arch integration point 124 is defined as a geometrical connection point between the base bowl lower hemisphere 102 and the domed lid upper hemisphere 103, whereby the geometrical connection point 124 provides substantially seamless curvature without gaps or changes in angulation, wherein once compressed together, substantially spherical interior surface 114 of the base bowl lower hemisphere 102 and the domed lid upper hemisphere 103 provide a continuously smooth transition.

In some embodiments of the rotation influencing culinary mixing container system 100, a plurality of lid locks 136 connected to the upper compression rim 106 in the pair of opposing compression rims 104/106 are included. Each lid lock 136 in the plurality of lid locks is connected to the upper compression rim in the pair of opposing compression rims by a living hinge 144. Each lid lock 136 in the plurality of lid locks includes an engagement latch 138 having an engagement surface 140 configured to put pressure against an opposing lower surface 142 of the upper rim 104 of the lower bowl 102, thereby locking the domed lid upper hemisphere 103 to the base bowl lower hemisphere 102 when engaged.

In some embodiments, a flat lid for storage of contents (not shown) of the rotation influencing culinary mixing container system 100 is included. While not explicitly shown in the drawings, flat lids are standard in food storage containers, and the lids herein provide no unique structure over what already exists in the market, other than the incorporation in to the system 100 disclosed herein.

In some embodiments, the domed lid upper hemisphere includes a removable cap at the upper center point. While not explicitly shown in the drawings, the cap is recited in its broadest sense, which can be taught by any number of caps in the market, and the caps herein provides no unique structure over what already exists in the market, other than the incorporation in to the system 100 disclosed herein.

In another exemplary embodiment, a method of configuring a culinary mixing container 100 for enhanced rotational influence is provided. The method includes providing a two-part culinary mixing container 100 having a domed lid upper hemisphere 103 and a base bowl lower hemisphere 102. The method requires implementing a spherical hollow cavity within the two-part culinary mixing container 100 by configuring a semi-spherical internal surface 114 in the domed lid upper hemisphere 103 with an opening at a lower linear surface, and configuring a semi-spherical internal surface 114 in the base bowl lower hemisphere 102 with an opening at an upper linear surface, whereby a circumference of the opening at the lower linear surface is identical to a circumference of the opening at the upper linear surface, as may be seen in FIGS. 2 and 3. The method further requires configuring a circumferential arch integration point 124 comprising an upper circumferential integration point 130 along a periphery of the opening at the upper linear surface of the domed lid upper hemisphere 103 and a lower circumferential integration point 132 along a periphery of the opening at the lower linear surface of the base bowl lower hemisphere 102, whereby once pressed together, the opening at the lower linear surface and the opening at the upper linear surface align forming a continuous arched surface 114 to thereby guide momentum generated from tossing and shaking contents within the substantially spherical interior in a circular directional motion 120 and influencing a rotation of the contents 118/122 to allow dry and wet particulates 118 to coat interior contents 122 evenly.

In some embodiments, the method further comprises configuring the circumferential arch integration point 124 for a temporary seal by including a circumferential rim 106 around the lower linear surface of the domed lid upper hemisphere 103 forming an upper rim 106, and an opposing circumferential rim 104 around the upper linear surface of the base bowl lower hemisphere 102 forming a lower rim 104, whereby pressing the upper rim 106 and the lower rim 104 together provides a temporary seal between the domed lid upper hemisphere 103 and the base bowl lower hemisphere 102.

In some embodiments, the method further comprises including a vertical securement lip 116 extending downwardly from an outer edge of the upper compression rim 106, whereby the securement lip 116 is geometrically configured to contain lateral movement of the lower compression rim 104, thereby securing the alignment of the spherical hollow cavity.

In some embodiments, the method further comprises including a recessed channel 128, recessing down from an upper surface 104b of the lower compression rim 104, and integrating a compressible gasket 126 within the recessed channel 128. The compressible gasket 126 is configured to seal the spherical hollow cavity 134 when compressed, while allowing the upper surface 104b of the lower compression rim 104 and the lower surface 106b of the upper compression rim 106 to press against one another. The configuration of the gasket 126 includes providing a gasket 126 of greater uncompressed height than a depth of the channel 128, with the capability of compression to a height of less than the depth of the channel 128.

In some embodiments, the method further comprises including a plurality of lockable latches 136 capable of holding the domed lid upper hemisphere 103 against the base bowl lower hemisphere 102, wherein each latch 136 in the plurality of latches is constructed of a living hinge 144 with an engagement surface 140 at a lower portion configured to put pressure against an opposing lower surface 142 of the upper rim 104 of the lower bowl 102, thereby locking the domed lid upper hemisphere 103 to the base bowl lower hemisphere 102 when engaged.

While there has been shown and described above the preferred embodiment of the instant invention it is to be appreciated that the invention may be embodied otherwise than is herein specifically shown and described and that certain changes may be made in the form and arrangement of the parts without departing from the underlying ideas or principles of this invention as set forth in the Claims appended herewith.

I claim:

1. A rotation influencing culinary mixing container system, comprising:
a hollow cavity-defining main body constructed of two hemispheres, wherein said two hemispheres include a base bowl lower hemisphere and a domed lid upper hemisphere;
said base bowl lower hemisphere, wherein said base bowl lower hemisphere is defined by a linear upper surface with a substantially circular opening in said upper surface and a semi-spherical cavity recessing down into said base bowl hemisphere with a diameter of said semi-spherical cavity decreasing in size as the spherical cavity reaches a lower center point;
said domed lid upper hemisphere, wherein said domed lid upper hemisphere is defined by a linear lower surface with a substantially circular opening in said lower surface and a semi-spherical cavity recessing up into said domed lid hemisphere with a diameter of said semi-spherical cavity decreasing in size as the spherical cavity reaches an upper center point;
a compression rim integrally formed onto each respective hemisphere extending laterally outward from said each respective substantially circular opening, thereby providing an upper surface and lower surface for user engagement and forming a pair of opposing compression rims; and
a substantially spherical interior surface bordering said hollow cavity, wherein said substantially spherical interior surface is formed from an alignment of said semi-spherical cavity of said base bowl lower hemisphere with said semi-spherical cavity of said domed lid upper hemisphere and said base bowl lower hemisphere and said domed lid upper hemisphere are pressed together, wherein said substantially spherical interior surface guides momentum generated from tossing and shaking contents within said substantially spherical interior in a circular directional motion and influencing a rotation of the contents to allow dry and wet particulates to coat interior contents evenly.

2. The rotation influencing culinary mixing container system, as recited in claim 1, wherein said pair of opposing compression rims formed into each respective hemisphere comprises:
an upper compression rim integrated to said domed lid upper hemisphere at said substantially circular opening in said lower surface of said domed lid upper hemisphere;
a lower compression rim integrated to said base bowl lower hemisphere at said substantially circular opening in said upper surface of said base bowl lower hemisphere; and
a circumferential channel recessed within said lower compression rim integrated to said base bowl lower hemisphere, wherein said circumferential channel is configured to receive a compressible gasket to seal a space between a lower surface of said upper compression rim and said lower compression rim.

3. The rotation influencing culinary mixing container system, as recited in claim 1, wherein an upper compression rim in said pair of opposing compression rims includes a vertical securement lip extending downwardly from an outer edge of said upper compression rim, whereby said securement lip contains lateral movement of said lower compression rim, thereby securing said alignment of said semi-spherical cavity of said base bowl lower hemisphere with said semi-spherical cavity of said domed lid upper hemisphere.

4. The rotation influencing culinary mixing container system, as recited in claim 3, further comprising:
a circumferential channel recessed within said lower compression rim integrated to said base bowl lower hemisphere, wherein said circumferential channel is configured to receive a compressible gasket to seal a space between a lower surface of said upper compression rim and said lower compression rim.

5. The rotation influencing culinary mixing container system, as recited in claim 1, further comprising:
a circumferential arch integration point formed from a domed lid upper hemisphere arch integration point and lower base bowl hemisphere arch integration point; and
said arch integration point is defined as a geometrical connection point between said base bowl lower hemisphere and said domed lid upper hemisphere, whereby said geometrical connection point provides substantially seamless curvature without gaps or changes in angulation, wherein once compressed together, substantially spherical interior surface of said base bowl lower hemisphere and said domed lid upper hemisphere provide a continuously smooth transition.

6. The rotation influencing culinary mixing container system, as recited in claim 1, further comprising:
a plurality of lid locks connected to said upper compression rim in said pair of opposing compression rims;
each lid lock in said plurality of lid locks is connected to said upper compression rim in said pair of opposing compression rims by a living hinge; and
each lid lock in said plurality of lid locks includes an engagement latch having an engagement surface configured to put pressure against an opposing lower surface of said upper rim of said lower bowl, thereby locking said domed lid upper hemisphere to said base bowl lower hemisphere when engaged.

7. The rotation influencing culinary mixing container system, as recited in claim 1, further comprising:
a flat lid for storage of contents of the rotation influencing culinary mixing container system.

8. The rotation influencing culinary mixing container system, as recited in claim 1, wherein said domed lid upper hemisphere includes a removable cap at said upper center point.

9. A method of configuring a culinary mixing container for enhanced rotational influence, comprising:
providing a two-part culinary mixing container having a domed lid upper hemisphere and a base bowl lower hemisphere;
implementing a spherical hollow cavity within said two-part culinary mixing container by configuring a semi-spherical internal surface in said domed lid upper hemisphere with an opening at a lower linear surface, and configuring a semi-spherical internal surface in said base bowl lower hemisphere with an opening at an upper linear surface, whereby a circumference of said opening at said lower linear surface is identical to a circumference of said opening at said upper linear surface; and
configuring an circumferential arch integration point comprising an upper circumferential integration point along a periphery of said opening at said upper linear surface of said domed lid upper hemisphere and a lower circumferential integration point along a periphery of said opening at said lower linear surface of said base bowl lower hemisphere, whereby once pressed together, said opening at said lower linear surface and said opening at said upper linear surface align forming a continuous arched surface to thereby guide momentum generated from tossing and shaking contents within said substantially spherical interior in a circular directional motion and influencing a rotation of the contents to allow dry and wet particulates to coat interior contents evenly.

10. The method of configuring a culinary mixing container for enhanced rotational influence, as recited in claim 9, further comprising:
configuring the circumferential arch integration point for a temporary seal by including a circumferential rim around the lower linear surface of the domed lid upper hemisphere forming an upper rim, and an opposing circumferential rim around the upper linear surface of the base bowl lower hemisphere forming a lower rim, whereby pressing said upper rim and said lower rim together provides a temporary seal between the domed lid upper hemisphere and the base bowl lower hemisphere.

11. The method of configuring a culinary mixing container for enhanced rotational influence, as recited in claim 10, further comprising:
including a vertical securement lip extending downwardly from an outer edge of said upper compression rim, whereby said securement lip is geometrically configured to contain lateral movement of said lower compression rim, thereby securing said alignment of said spherical hollow cavity.

12. The method of configuring a culinary mixing container for enhanced rotational influence, as recited in claim 10, further comprising:
including a recessed channel, recessing down from an upper surface of said lower compression rim; and
integrating a compressible gasket within said recessed channel, whereby said compressible gasket is configured to seal the spherical hollow cavity when compressed, while allowing the upper surface of the lower compression rim and the lower surface of the upper compression rim to press against one another, whereby said configuration of said gasket includes providing a gasket of greater uncompressed height than a depth of said channel, with the capability of compression to a height of less than said depth of said channel.

13. The method of configuring a culinary mixing container for enhanced rotational influence, as recited in claim 9, further comprising:
including a plurality of lockable latches capable of holding said domed lid upper hemisphere against said base bowl lower hemisphere, wherein each latch in said plurality of latches is constructed of a living hinge with an engagement surface at a lower portion configured to put pressure against an opposing lower surface of said upper rim of said lower bowl, thereby locking said domed lid upper hemisphere to said base bowl lower hemisphere when engaged.
